(19) United States
(12) Patent Application Publication
(10) Pub. No.: US 2026/0034558 A1
(43) Pub. Date: Feb. 5, 2026

(54) NOZZLE DEVICE FOR DISPENSING A SQUIRT JET OF AN APPLICATION MATERIAL

(71) Applicant: Dürr Systems AG, Bietigheim-Bissingen (DE)

(72) Inventor: Bernd Kraft, Steinheim a.d. Murr (DE)

(21) Appl. No.: 18/998,799

(22) PCT Filed: Jul. 25, 2023
(86) PCT No.: PCT/EP2023/070548

§ 371 Date: Jan. 27, 2025

(30) Foreign Application Priority Data
Jul. 28, 2022 (DE) 10 2022 118 975.9

(51) Int. Cl. B05C 5/02

(52) U.S. Cl. CPC B05C 5/0283; B05C 5/0254

(57) ABSTRACT

A nozzle device for dispensing a squirt jet of an application material, comprising a, slot-shaped, outlet opening for the application material and a nozzle element, wherein the nozzle device and/or the nozzle element has an asymmetrical distribution recess for the application material, to distribute a material quantity asymmetrically along the outlet opening and/or to dispense a material quantity that changes, continuously, along the outlet opening. The disclosure also relates to an associated application method.

### CROSS-REFERENCE TO RELATED APPLICATIONS

This application is a national stage of, and claims priority to, Patent Cooperation Treaty Application No. PCT/EP2023/070548, filed on Jul. 25, 2023, which application claims priority to German Application No. DE 10 2022 118 975.9, filed on Jul. 28, 2022, which applications are hereby incorporated herein by reference in their entireties.

### FIELD OF THE DISCLOSURE

The disclosure relates to a nozzle device for dispensing a (asymmetrical or substantially symmetrical) squirt jet of an (e.g. viscous or highly viscous) application material, wherein the nozzle device has an outlet opening for the application material and at least one nozzle element (e.g. a nozzle plate). The disclosure also relates to an associated application method.

### BACKGROUND

When applying in particular highly viscous application material (e.g. PVC materials) using, e.g., airless nozzles, flat stream nozzles, extrusion nozzles, nozzles with 2- or 3-plate technology and fine seam nozzles, a symmetrical squirt jet is usually generated. This means that the squirt jet always emerges symmetrically from both sides relative to the center point of the outlet opening and thus from the nozzle. This means that the squirt jet is exactly of the same width on both sides from the center point of the outlet opening and, in particular, has the same material quantity on both sides.

DE 10 2006 012 373 B3 discloses a nozzle for applying highly viscous material that is deposited in strips on a substrate, with a nozzle body that is attached to a discharge device, wherein the nozzle has two offset and parallel slot-shaped openings of different slot lengths. Here, the substrate is coated symmetrically. However, the substrate is deliberately coated with two different layer thicknesses. The nozzle produces two symmetrical squirt jets with different jet width. The two slot-shaped openings are arranged one behind the other. The longer opening precedes the shorter opening during application (a few millimeters). This results in an application with two different layer thicknesses, namely a high layer thickness in the middle and a low layer thickness on the outside. One disadvantage of the nozzle is, e.g., that a very high material quantity is applied therewith because the substrate is coated with two squirt jets. This in turn means very high application speeds. Coatings of less than, e.g., 600 μm are not achievable or only with difficulty. In addition, the nozzle can only be used to apply in one direction in the visible range, since the longer opening always precedes the shorter opening. Furthermore, the nozzle does not allow for a layer thickness on the substrate that continuously changes in cross-section. Rather, a “step” forms at the transition from high to low layer thickness.

### BRIEF DESCRIPTION OF THE DRAWINGS

FIG. 1 is a perspective view of a nozzle device according to an embodiment of the disclosed technology,

FIG. 2 shows a nozzle element according to an embodiment of the disclosure,

FIG. 3 shows a further nozzle element according to an embodiment of the disclosure,

FIG. 4 shows an additional nozzle element according to an embodiment of the disclosure,

FIG. 5 shows the nozzle element and the further nozzle element in the operating position, in particular with a schematically represented material quantity, which is distributed asymmetrically along an outlet opening and/or changes along the outlet opening, according to an embodiment of the disclosure,

FIG. 6 is a highly schematic view on a front side of three nozzle elements according to an embodiment of the disclosure,

FIG. 7 shows a nozzle element and a further nozzle element according to another embodiment of the disclosure,

FIGS. 8A and 8B is a highly schematically represented asymmetrical squirt jets, in particular with asymmetrically changed jet width according to an embodiment of the disclosure,

FIG. 9 shows an application scheme, in particular a schematically represented plan view on an application (e.g. an application path) according to an embodiment of the disclosure,

FIGS. 10A to 10D illustrate application constellations for coating a curved motor vehicle component,

FIG. 11 schematically illustrates the state of the art, in which a material quantity is distributed symmetrically along an outlet opening and/or a constant material quantity is dispensed along the outlet opening,

FIGS. 12 to 14 show a nozzle device, in particular a nozzle element and a further nozzle element according to an embodiment of the disclosure,

FIG. 15 is a schematic representation of the mode of operation of the embodiment of FIGS. 12 to 14, in particular according to the “path resistances” principle,

FIGS. 16 to 18 show a nozzle device, in particular a nozzle element and a further nozzle element according to another embodiment of the disclosure, and

FIG. 19 is a schematic representation of the mode of operation of the embodiment of FIGS. 16 to 18, in particular according to the “gap resistances” principle.

Embodiments of the disclosed technology described with reference to the figures correspond in part, wherein similar or identical parts are provided with the same reference signs and, in order to avoid repetition, reference can also be made to the description of the other embodiments for their explanation. For purposes of illustration, not all parts are provided with reference signs in all figures.

### DETAILED DESCRIPTION

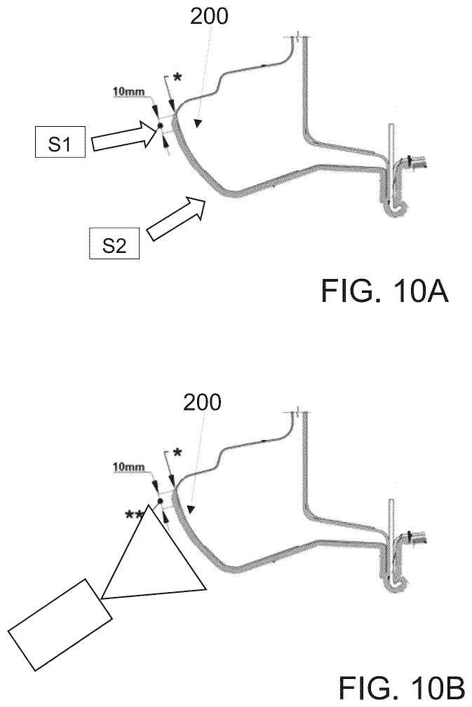

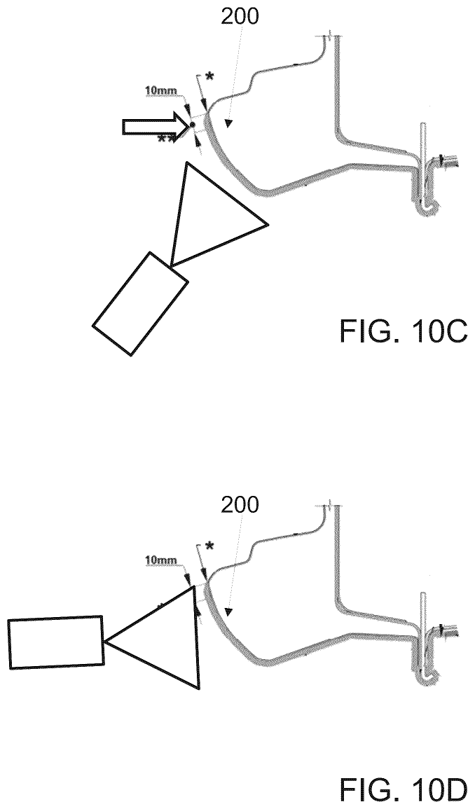

A squirt jet that produces a uniform layer thickness on a substrate can be disadvantageous, particularly on curved substrates such as a sill for a motor vehicle, as explained by way of example in FIGS. 10A to 10B.

It is often desirable, as illustrated in FIG. 10A, for the lower region of the sill to have a high layer thickness S2 and the upper region to have a lower layer thickness S1, in particular the layer thickness decreases continuously from bottom to top.

If the sill is coated with a squirt jet that produces a uniform, symmetrical layer thickness, using a, e.g., highly viscous application material with the applicator (e.g. atomizer) at the setting angle shown in FIG. 10B (e.g. 90° to the surface of the sill), an almost homogeneous layer thickness is produced on the surface.

To create more layer thickness in the lower region and a layer thickness that flattens towards the top using such a squirt jet, the setting angle is usually changed as shown in FIG. 10C. However, this makes the upper edge (see arrow in FIG. 10C) of the application unsharp. The application image is not accepted by the customer.

If, on the other hand, a sharp edge is desired, the applicator is usually set as shown in FIG. 10D. With this setting angle of the applicator, a clean upper edge can be achieved, but here a very high layer thickness is obtained in the upper visible region and a low layer thickness in the lower visible region. Thus, the customer's requirements are also not met.

The technology disclosed herein provides an alternative and/or improved nozzle device, such as a nozzle device with which an application with a changing layer thickness can be produced, e.g. a layer thickness that changes continuously, e.g. continuously increases.

The disclosure relates to a nozzle device for dispensing a, e.g. asymmetrical or substantially symmetrical, squirt jet of an application material, for producing an application on a motor vehicle component (e.g. a vehicle body and/or an attachment part for this, e.g. a sill).

The nozzle device comprises a (front-sided and/or slot-shaped, in particular elongated) outlet opening for the application material and at least one nozzle element.

The outlet opening can, e.g., be formed straight or convexly curved.

The nozzle element and/or the nozzle device has an asymmetrical distribution recess (e.g. an asymmetrical outlet contour) for the application material, e.g. in order to distribute a material quantity asymmetrically along the outlet opening and/or to dispense a material quantity that changes (continuously) along the outlet opening, such that the material quantity changes continuously, e.g. increases continuously, at least partially along the outlet opening or along the substantially entire outlet opening.

This makes it advantageously possible to generate a squirt jet whose material quantity (e.g. continuously) changes over the jet width of the squirt jet.

This makes it advantageously possible to generate an application with a changing layer thickness, e.g. on a motor vehicle component, e.g. a layer thickness that continuously changes, e.g. continuously increases.

The distribution recess can, e.g., have an indentation for the application material, e.g. for accumulating the application material.

The indentation can be a concave indentation, in particular a concavely curved indentation.

However, it is possible that the indentation can have other suitable geometries, such as a polygonal and/or straight shaped indentation.

It is possible that the distribution recess, in particular the indentation, has a distribution edge for the application material that is curved and/or inclined towards the outlet opening. The application material can be supplied to the outlet opening via the distribution edge.

The nozzle device, the distribution recess, the distribution edge, the distribution slot mentioned below and/or the indentation can generate in particular different gap resistances, path resistances and/or flow resistances for the application material, according to which the application material can be advantageously distributed along the outlet opening.

The gap resistances, path resistances and/or flow resistances can increase (continuously), e.g., along the distribution recess and/or the distribution slot mentioned below.

The indentation and/or the distribution edge can be formed at least partially, e.g., straight (e.g. polygonal), can have at least partially an arcuate shape with a substantially constant curvature and/or can have at least partially an arcuate shape with a, continuously, changing curvature.

The arcuate shape can, e.g., substantially correspond to a circular arcuate shape, or can deviate from a circular arcuate shape.

The nozzle element can, e.g., have a feed channel for feeding the application material. The feed channel can open into the distribution recess in order to be able to feed the application material to the distribution recess.

The nozzle element can have an, front-sided, in particular straight or convexly curved, squirting edge for the application material.

It is possible that the indentation and the squirting edge create an asymmetrical nozzle element contour.

The concave indentation and the convexly curved squirting edge can create an asymmetrical concave-convex nozzle element contour and/or an asymmetrical nozzle element contour.

It is possible that a distance (e.g. a passage gap) is defined between the distribution edge and the squirting edge and that the distance increases along the distribution edge by at least the factor of 1.2; 1.5; 2.0; 2.5; or 3.0. Alternatively or in addition, the material quantity along the outlet opening can increase, e.g. by at least the factor of 1.2; 1.5; 2.0; 2.5; or 3.0.

The distance can, e.g., be greater on the one side of the center plane (see below) by at least the factor of 1.2; 1.5; 2.0; 2.5; or 3.0 than on the other side of the center plane.

The distribution recess, the indentation and/or the feed channel can penetrate the nozzle element completely.

It is possible that the nozzle device has an (e.g. elongated, asymmetrical and/or sickle-shaped) distribution slot for the application material.

It is possible that the distribution slot forms at least a part of the distribution recess, extends in an arc shape and/or narrows (e.g. continuously) along its longitudinal extension, in particular starting from its inlet.

It is possible that the distribution slot is delimited by at least a convex, arcuate, edge segment and/or a concave, arcuate, edge segment.

The concave edge segment extends opposite the convex edge segment, in order to form the distribution slot therebetween.

The convex edge segment can, e.g., have a longitudinal extension and the concave edge segment can, e.g., have a longitudinal extension, wherein the longitudinal extension of the convex edge segment can be smaller than the longitudinal extension of the concave edge segment.

Alternatively or additionally, the convex edge segment and the concave edge segment can have, e.g., different radii of curvature, in order to narrow (in particular continuously) the distribution recess and/or the distribution slot along its longitudinal extension.

It is possible that the distribution recess, the distribution slot, the indentation, the distribution edge, the concave edge segment and/or the convex edge segment are curved towards the outlet opening.

The nozzle device can, e.g., have a further nozzle element and/or an additional nozzle element.

The further nozzle element can, e.g., have a (substantially symmetrical or asymmetrical) distribution recess for the application material.

The further nozzle element can, e.g., have a straight or a convexly curved squirting edge.

It is possible that the nozzle element and/or the further nozzle element has a feed channel for feeding the application material, wherein the feed channel can open, centrally or decentrally, into the distribution recess of the nozzle element and/or the distribution recess of the further nozzle element.

The feed channel of the nozzle element and/or of the further nozzle element can, e.g., have an entry opening for the application material on a front side of the nozzle element and/or of the further nozzle element. The entry opening and the outlet opening are aligned in opposite directions.

The feed channel of the nozzle element and/or of the further nozzle element can, towards the distribution recess of the nozzle element and/or of the further nozzle element, narrow, widen and/or have a substantially constant passage cross-section.

The distribution recess and/or the distribution slot, in particular of the nozzle element and/or of the further nozzle element, can have a longitudinal side and a front side, wherein the application material can be introducible, e.g., via the longitudinal side and/or via the front side into the distribution recess and/or the distribution slot, in particular of the nozzle element and/or of the further nozzle element.

The longitudinal side of the distribution recess and/or of the distribution slot can be open for the application material, so that application material can be introduced via the longitudinal side, or closed, so that no application material can be introduced via the longitudinal side.

It is possible that the application material flows through the distribution recess and/or the distribution slot in the longitudinal direction of the distribution recess and/or of the distribution slot of the nozzle element and/or of the further nozzle element and exits the distribution recess and/or the distribution slot transversely to the longitudinal direction, wherein the distribution recess and/or the distribution slot generates in particular different path resistances for the application material.

It is also possible that the application material flows transversely to the longitudinal direction of the distribution recess and/or of the distribution slot of the nozzle element and/or of the further nozzle element into the distribution recess and/or the distribution slot and (in particular after a change of direction) exits the distribution recess and/or the distribution slot transversely to the longitudinal direction, wherein the distribution recess and/or the distribution slot generates in particular different gap resistances for the application material.

It is possible that the distribution recess of the nozzle element and the distribution recess of the further nozzle element overlap one another partially and/or form a common distribution chamber for the application material.

The concave edge segment and the convex edge segment can be part of the nozzle element.

Alternatively or in addition, the further nozzle element can have a further convex, arcuate, edge segment. The further convex edge segment extends opposite the concave edge segment, in order to form the distribution slot there between.

It is possible that the convex edge segment of the further nozzle element also delimits the distribution slot and/or extends along its longitudinal extension substantially parallel and/or substantially flush to the convex edge segment of the nozzle element.

The convex edge segment can, e.g., be part of the nozzle element.

The concave edge segment can, e.g., be part of the further nozzle element.

It is possible that the concave edge segment is formed by a distribution edge of the nozzle element and/or by a, arcuate, distribution edge of the further nozzle element.

The nozzle element and/or the further nozzle element, in particular the distribution recess of the further nozzle element and/or the distribution recess of the nozzle element, can have, e.g., at least one of the following: a central recess, both-sided outside protruding projections, and/or both-sided between the projections and the central recess respectively a (substantially straight) edge region, which can extend, e.g., orthogonally to the center plane (e.g. a first edge region and a second edge region).

The feed channel of the nozzle element is arranged substantially centrally relative to the outlet opening and/or relative to the central recess of the further nozzle element.

The central recess can, e.g., have a central (in particular bottom-sided) arcuate section and two outer (in particular lateral) side sections (e.g. arcuate sections or linear sections) adjacent to the central arcuate section, e.g. a first outer side section (e.g. arcuate section or linear section) and a second outer side section (e.g. arcuate section or linear section).

It is possible that the distribution edge (in particular on the squirting side) connects with a first end to a transition region between the first outer side section (e.g. arcuate or linear section) and the first edge region, e.g. connects to the first outer side section (e.g. arcuate or linear section) or to the first edge region or connects substantially directly there between. Alternatively or in addition, the distribution edge (in particular on the feeding side) can connect with a second end, e.g., to a transition region between the central arcuate section and the second outer side section (e.g. arcuate or linear section), e.g. connect to the central arcuate section or to the second outer side section (e.g. arcuate or linear section) or substantially directly there between.

It is possible that the distribution recess of the nozzle element (in particular with its inlet side) connects substantially flush to the central arcuate section (in particular to an outlet side of the central arcuate section).

The distribution recess of the nozzle element and/or the distribution slot can, e.g., squirt-sided be open or closed.

The distribution recess of the further nozzle element can, e.g., squirt-sided be open or closed.

The feed channel, the distribution slot and/or the distribution recess in particular of the nozzle element can extend completely orthogonally through the nozzle element, and thus in particular completely penetrate the nozzle element, orthogonally to its element plane.

The feed channel, the distribution slot and/or the distribution recess of the further nozzle element can extend completely orthogonally through the further nozzle element, and thus in particular completely penetrate the further nozzle element, e.g. orthogonally to its element plane.

The distribution recess of the nozzle element can, e.g., open into the distribution recess of the further nozzle element substantially orthogonally to the nozzle element, at least partially within and/or at least partially outside the central recess of the further nozzle element.

The distribution edge, the concave edge segment and/or the convex edge segment of the nozzle element and/or of the further nozzle element can be arranged, e.g., between the two projections and/or between the two edge regions of the nozzle element and/or of the further nozzle element. Here, the concave edge segment can, for example, connect the two edge regions to one another, wherein, alternatively or additionally, the convex edge segment can be spatially distanced from the first edge region, e.g. in order to create a passage for the application material. The convex edge segment can be connected, e.g., to the second edge region, e.g., in order not to create a passage for the application material.

The (e.g. symmetrical) distribution recess of the further nozzle element can be delimited, e.g., by two side edges which widen towards the concave edge segment of the further nozzle element and connect on both sides to the concave edge segment of the further nozzle element. Here, the concave edge segment of the further nozzle element can, e.g., squirt-sided delimit the distribution recess of the further nozzle element.

Here, the concave edge segment of the further nozzle element can correspond, e.g., to a distribution edge for the application material, wherein the application material can be fed to the outlet opening via the distribution edge.

The nozzle device can, e.g., comprise an additional nozzle element, which can, e.g., comprise a front-sided (in particular straight or convexly curved) squirting edge.

In the context of the disclosure, the additional nozzle element can be designed to be substantially identical in construction to the nozzle element and/or to the further nozzle element, so that the disclosure for the nozzle element and/or for the further nozzle element also applies to the additional nozzle element.

The additional nozzle element can thus have the features of the nozzle element and/or the features of the further nozzle element as disclosed herein.

The additional nozzle element can thus, e.g., have a distribution recess, an indentation, a distribution edge, a feed channel, a distribution slot, a concave edge segment, a convex edge segment and/or a squirting edge, in particular as disclosed herein for the nozzle element and/or the further nozzle element.

The nozzle device can thus comprise the nozzle element, the further nozzle element and/or the additional nozzle element.

The further nozzle element can be arranged between the nozzle element and the additional nozzle element, e.g. directly there between.

The nozzle element can, e.g., be arranged between the further nozzle element and the additional nozzle element, e.g. directly there between.

It is possible that the distribution recess, the indentation, the distribution edge, the distribution slot, the concave edge segment, the convex edge segment, the feed channel and/or the squirting edge of the nozzle element and a distribution recess, an indentation, a distribution edge, a distribution slot, a concave edge segment, a convex edge segment, a feed channel and/or a squirting edge of the further nozzle element and/or of the additional nozzle element are aligned substantially flush with one another (in particular arranged substantially congruently) and/or extend substantially parallel to one another.

The distribution recess, the indentation, the distribution edge, the distribution slot, the concave edge segment, the convex edge segment, the feed channel and/or the squirting edge of the nozzle element and of the further nozzle element and/or of the additional nozzle element can be formed to be substantially identical in construction.

The outlet opening can extend along, e.g., between the squirting edge of the nozzle element and the squirting edge of the further nozzle element and/or of the additional nozzle element.

The outlet opening can extend along, e.g., between the squirting edge of the further nozzle element and the squirting edge of the additional nozzle element.

The nozzle device can have, e.g., a center plane, wherein the center plane can be defined by a center axis of the outlet opening and can be aligned, e.g., substantially orthogonally to the (slot-shaped and/or elongated) outlet opening, in particular, e.g., substantially orthogonally to the element plane (plate plane) of the nozzle element, of the further nozzle element and/or of the additional nozzle element.

The center plane can, e.g., divide a length of the outlet opening and/or a length of the squirting edge of the nozzle element and/or of the additional nozzle element into two halves of substantially the same length.

The distribution recess, the distribution slot, the feed channel, in particular its entry opening, the indentation, the convex edge segment and/or the distribution edge of the nozzle element can be formed to be, e.g., asymmetrical or substantially symmetrical in particular relative to the center plane.

Alternatively or additionally, the distribution recess, the feed channel, in particular its entry opening, the convex edge segment and/or concave edge segment of the further nozzle element can be formed to be, e.g., asymmetrical or substantially symmetrical relative to the center plane.

The concave edge segment of the nozzle element and/or of the further nozzle element can be formed, e.g., substantially symmetrically relative to the center plane.

For example, the distribution recess, the distribution slot and/or the indentation of the nozzle element can be arranged eccentrically relative to the center plane, e.g. by more than 50%, 60%, 70% or 80%, so that in particular the distribution recess, the distribution slot and/or the indentation can be arranged more than 50%, 60%, 70% or 80% on one side of the center plane and the remainder can be arranged on the other side of the center plane.

It is possible that the projections are arranged substantially flush with the squirting edge of the nozzle element, with the squirting edge of the further nozzle element and/or with the squirting edge of the additional nozzle element, in particular so that the projections delimit the outlet opening both-sided outside and/or there is, between the projections and the squirting edge of the nozzle element, the squirting edge of the further nozzle element and/or the squirting edge of the additional nozzle element, both-sided no passage gap for the application material.

Alternatively, it is possible that the projections are offset (set back) to the squirting edge of the nozzle element, the squirting edge of the further nozzle element and/or the squirting edge of the additional nozzle element, in order to create (one-sided or both-sided) a passage gap (e.g. with a height of between 0.1 mm and 2.0 mm) for the application material. This can advantageously reduce edge accumulation in an application created on the motor vehicle component.

It is possible that at least one of the following is (in particular relative to the center plane) substantially aligned centrally and/or formed symmetrically: the outlet opening, the feed channel, in particular its entry opening, of the nozzle element and/or of the further nozzle element, the squirting edge of the nozzle element and/or of the further nozzle element, the concave edge segment of the nozzle element and/or of the further nozzle element, the distribution recess of the further nozzle element and/or the squirting edge of the additional nozzle element.

Alternatively or additionally, e.g., the two edge regions and/or the two projections of the nozzle element and/or of the further nozzle element can be aligned substantially centrally and/or can be formed substantially symmetrical (in particular relative to the center plane).

The indentation, the distribution edge, the distribution recess, the distribution slot, the concave edge segment and/or the convex edge segment of the nozzle element and/or of the further nozzle element can have, e.g., a chord, wherein the chord, relative to the center plane, can have a chord angle of less than 90°, 85° or 80° and/or of greater than 55°, 60° or 65°.

The concave edge segment of the nozzle element and/or of the further nozzle element can have, e.g., a chord that can, relative to the center plane, have a chord angle of, e.g., substantially 90°.

It is possible that the nozzle element is a nozzle plate, the further nozzle element is a nozzle plate and/or the additional nozzle element is a nozzle plate.

The asymmetry (e.g. of the distribution recess, of the indentation and/or of the distribution edge of the nozzle element, but also of the other asymmetrical parts as disclosed herein) can be linear or non-linear (e.g. from left to right). The asymmetry can be varied.

The asymmetry can also be formed asymmetrically from the center plane to only one side, wherein in particular the ratio between center plane and outer region of the distribution recess can be, e.g., at least 1.5; 2.0; or 2.5.

At the outlet opening, the material quantity can increase substantially continuously from one side of the outlet opening (e.g. left) to the other side of the outlet opening (e.g. right).

It should be mentioned that the nozzle element and the further nozzle element and optionally the additional nozzle element shape the squirt jet, in particular with regard to the material quantity distribution along the outlet opening.

The nozzle element and/or the additional nozzle element is used to laterally delimit the outlet opening and/or the distribution recess of the further nozzle element.

It is also possible that the further nozzle element and/or the additional nozzle element is used to laterally delimit the outlet opening and/or the distribution recess of the nozzle element.

The nozzle device is used for producing a substantially overspray-free squirt jet.

The application material can, e.g., be a viscous or highly viscous application material.

The application material can, e.g., be a plastisol, in particular a PVC plastisol (PVC: polyvinyl chloride).

The application material can, e.g., be a paint.

The outlet opening is slot-shaped, in particular with an longitudinal extension.

The nozzle element, the further nozzle element and/or the additional nozzle element can be an outer plate.

The nozzle element and/or the further nozzle element can, e.g., be an inner plate.

It should be mentioned that the nozzle element and/or the further nozzle element, in particular the distribution recess of the further nozzle element and/or the distribution recess of the nozzle element, can, e.g., have a central recess, both-sided outside protruding projections and/or two edge regions.

In the context of the disclosure, embodiments are possible in which the nozzle element and/or the further nozzle element can have a particularly asymmetrical distribution recess for the application material, in order to distribute a material quantity asymmetrically along the outlet opening and/or in order to dispense a material quantity that changes, continuously, along the outlet opening.

The disclosure also includes an application robot with a nozzle device as disclosed herein. The application robot is used for guiding the nozzle device along a motor vehicle component, in particular a curved motor vehicle component.

The motor vehicle component can, e.g., be a vehicle body and/or an attachment part for it.

The motor vehicle component can, e.g., be a sill.

The application robot can, e.g., have several robot arms and, in particular, a multi-axis robot hand.

The disclosure also relates to an application method with a nozzle device for dispensing an (e.g. asymmetrical or substantially symmetrical) squirt jet of an application material onto a (curved) motor vehicle component.

The nozzle device comprises a (front-sided, slot-shaped and/or convexly curved) outlet opening for the application material and a nozzle element, wherein the nozzle device and/or the nozzle element has an asymmetrical distribution recess for the application material, so that a material quantity is distributed asymmetrically along the outlet opening and/or a material quantity that changes (e.g. substantially continuously) along the outlet opening is dispensed.

The application method can be carried out in particular with a nozzle device and/or an application robot as disclosed herein.

The disclosure for the nozzle device and/or for the application robot thus applies accordingly to the application method and vice versa.

It is possible that, on the motor vehicle component, an application path is created with a substantially continuously changing (increasing) layer thickness of the application material, with a layer thickness of the application material that increases or decreases substantially continuously from top to bottom.

The application path can, e.g., in cross-section be asymmetrical and/or curved. Alternatively or in addition, the application path can advantageously terminate with an in particular sharp application edge. In the context of the disclosure, a sharp application edge is understood to mean a substantially straight edge which, in particular when viewed with the human eye, has no discernible waves and/or whose layer thickness distribution is so homogeneous that a smooth surface condition is discernible to the human eye. The waves can have a protrusion dimension of, e.g., less than 2.0 mm; 1.5 mm; 1 mm; 0.5 mm; 0.2 mm or 0.1 mm.

On the motor vehicle component, e.g. several application paths (running substantially parallel) can be produced with a changing layer thickness of the application material, wherein adjacent application paths can overlap one another, to produce a substantially constant layer thickness of the application.

The squirt jet can be formed, e.g., asymmetrically or substantially symmetrically, e.g. in dependence on an application agent volumetric flow.

It is possible that, in dependence on an (e.g. only temporarily changed) application material volumetric flow, the squirt jet and/or a jet width of the squirt jet is changed asymmetrically, e.g. relative to the center axis of the outlet opening, in particular relative to the center plane.

Thus, a jet width can, e.g., increase or decrease more on one side of the center axis of the outlet opening than on the other side of the center axis, whereby, e.g., a squirt jet can be generated whose jet width is, relative to the center axis of the outlet opening, greater on one side than on the other side. Consequently, a jet width on one side of the center axis of the outlet opening can, e.g., be greater than a jet width on the other side of the center axis of the outlet opening.

A center axis of the squirt jet can deviate from a center axis of the outlet opening.

An asymmetrical squirt jet can be used, e.g., to, in an advantageous manner, deliberately bypass partial sections (e.g. holes or bolts) on the motor vehicle component by the squirt jet, optionally in combination with an evasive movement of the nozzle device (of e.g. only approx. 2 mm to 4 mm) (generated by an application robot.)

By changing an application material volumetric flow, the jet width of the spray jet can thus also be changed. However, this in particular does not happen symmetrically. Rather, the squirt jet can be offset relative to the center axis of the outlet opening. The more application material flows, the more centered the squirt jet comes out of the outlet opening.

In the context of the disclosure, it is thus possible, e.g., that the jet width can change asymmetrically, in particular relative to the center axis of the outlet opening, in particular relative to the center plane. In contrast to this, when an application material volumetric flow of a conventional symmetrical nozzle configuration is changed, the jet width does not change asymmetrically, but equally on both sides.

It is possible that the outlet opening with its center axis has a setting angle of, e.g., between 85° and 95° (in particular substantially) 90° relative to the application surface of the motor vehicle component during the dispensing of the application material.

The motor vehicle component can be curved and/or a sill.

The squirt jet can be applied, e.g., to a convexly curved surface of the motor vehicle component.

It is possible that an application produced on the motor vehicle component has, in a lower region of the motor vehicle component, e.g., a greater or smaller layer thickness than in an upper region of the motor vehicle component. Alternatively or in addition, it is possible that a layer thickness of an application produced on the motor vehicle component decreases or increases, in particular continuously, from a lower region of the motor vehicle component to an upper region of the motor vehicle component.

The application is a coating, e.g. in particular a coating produced by the application material on the motor vehicle component.

The application can, e.g., be a visible application, that is to say in particular an application in the outer visible region of the motor vehicle component, which is why it is usually produced to be of high quality.

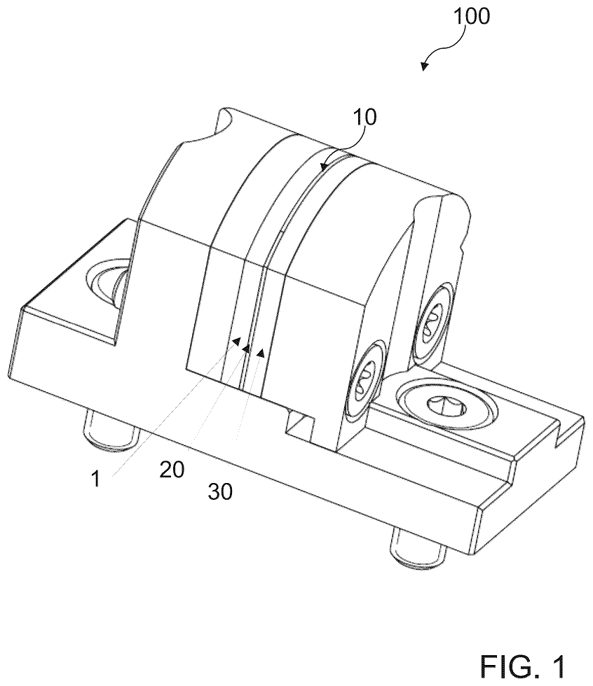

In the following, a nozzle device 100 according to an embodiment of the disclosure is described with reference to FIGS. 1 to 6.

Here, FIG. 1 shows a perspective view of the nozzle device 100, which has a front-sided, slot-shaped, convexly curved outlet opening 10 for dispensing a, asymmetrical or substantially symmetrical, squirt jet S of an application material. Alternatively, the outlet opening 10 can also be formed, e.g., to be straight.

The squirt jet S can be applied, e.g., to a curved motor vehicle component 200, in particular to a sill as shown, e.g., in FIGS. 10A to 10D.

The nozzle device 100 comprises several nozzle elements, namely a nozzle element 1, a further nozzle element 20 and an additional nozzle element 30, which can delimit the outlet opening 10 and can be formed in particular as nozzle plates. The further nozzle element 20 is arranged between the nozzle element 1 and the additional nozzle element 30. The nozzle element 1, the further nozzle element 20 and the additional nozzle element 30 can be clamped between two clamping parts.

The nozzle element 1 and/or the nozzle device 100 comprises an asymmetrical distribution recess 2 for the application material. The asymmetrical distribution recess 2 makes it possible, in particular, to distribute a material quantity asymmetrically along the outlet opening 10 and/or to dispense a material quantity that changes along the outlet opening 10, wherein the material quantity can increase continuously, in particular along the outlet opening 10. Thus, a squirt jet S can be advantageously generated whose material quantity changes also asymmetrically over the jet width sb of the squirt jet S.

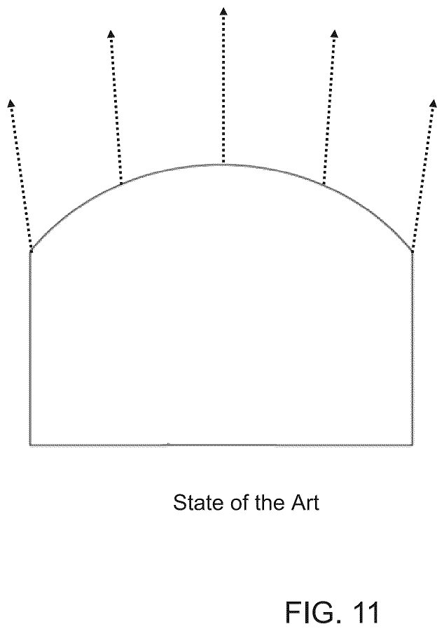

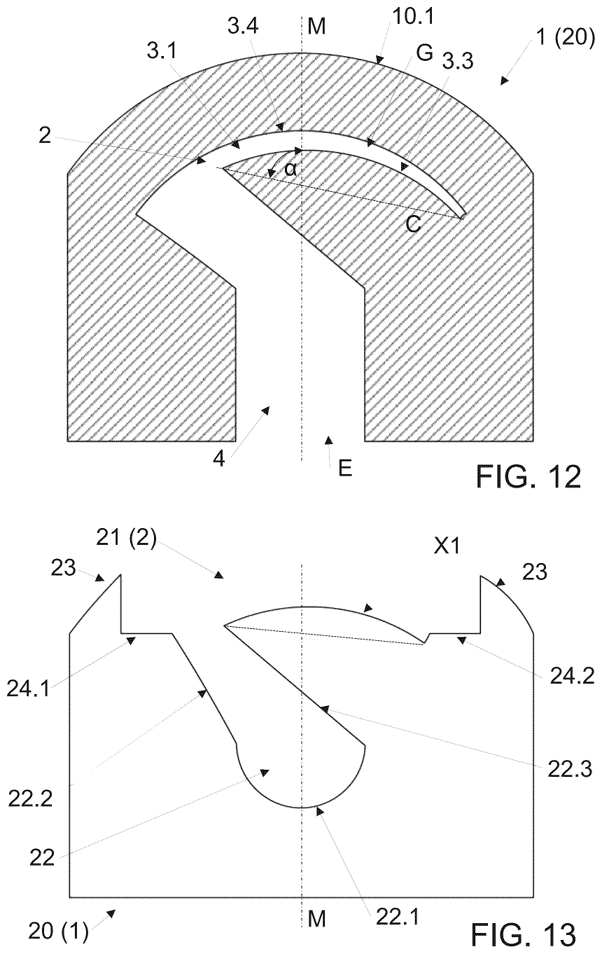

In contrast, FIG. 11 schematically shows state of the art, in which a material quantity is distributed symmetrically along an outlet opening and/or a constant material quantity is dispensed along the outlet opening.

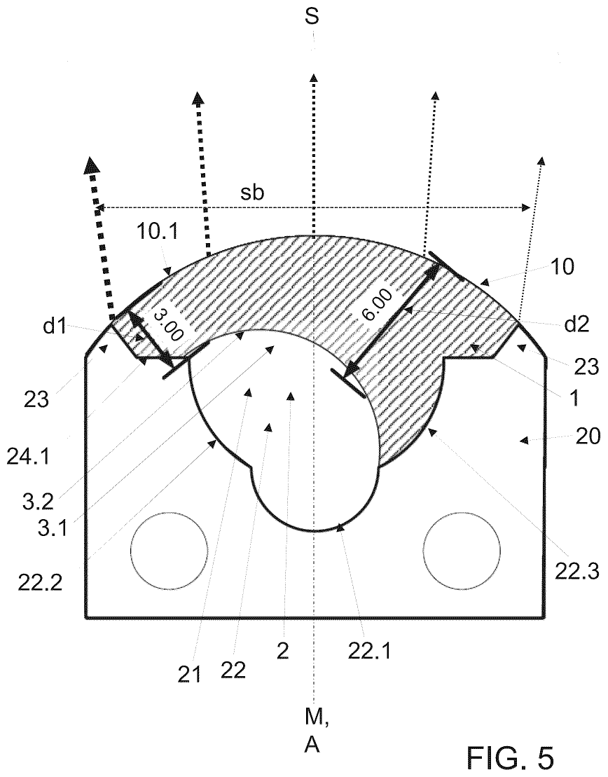

As shown schematically in FIG. 5, e.g., the material quantity can increase substantially continuously along the outlet opening 10 (e.g. from right to left).

The distribution recess 2 comprises a concavely curved indentation 3.1 and a front-sided, curved distribution edge 3.2 for the application material, wherein the indentation 3.1 and/or the distribution edge 3.2 can also be, at least partially, straight and/or polygonal.

The indentation 3.1 serves for accumulating the application material, wherein the application material can be fed to the outlet opening 10 via the distribution edge 3.2.

The indentation 3.1 and/or the distribution edge 3.2 can be formed, at least partially, straight (e.g. polygonal), can have, at least partially, an arcuate shape with constant curvature (e.g. constant radius of curvature r3) and/or can have, at least partially, an arcuate shape with a, continuously, changing curvature (e.g. changing radius of curvature r3).

The arcuate shape can, e.g., substantially correspond to a circular arcuate shape, although other (e.g. curved and/or at least partially straight) shapes are also possible.

The nozzle element 1 also has a feed channel 4 for feeding the application material, wherein the feed channel 4 opens into the distribution recess 2.

The nozzle element 1 also comprises a front-sided, in particular convexly curved squirting edge 10.1. Alternatively, the nozzle element 1 can also have a straight squirting edge 10.1.

The nozzle element 1 can thus comprise a, e.g., concave indentation 3.1 and a, e.g., convex squirting edge 10.1 and thus have an asymmetrically concave-convex nozzle element contour.

As shown in FIG. 5, a distance d1, d2 (a passage gap) can be defined between the distribution edge 3.2 and the squirting edge 10.1, wherein the distance d1, d2 can increase along the distribution edge 3.2, e.g., by at least the factor of 1.2; 1.5; 2.0 or 2.5. In FIG. 5, the distance d1, d2 increases, for example, from left to right, continuously. The distance d1 can, e.g., be 3 mm and the distance d2 can, e.g., be 6 mm.

The material quantity can, e.g., along the outlet opening 10, at least partially increase, at least partially decrease and/or at least partially remain substantially constant.

However, it is also possible, e.g., that the material quantity increases along the substantially entire outlet opening 10.

The material quantity can, e.g., increase substantially continuously, in particular by at least the factor of 1.2; 1.5; 2.0 or 2.5.

The further nozzle element 20 has in particular a substantially symmetrical distribution recess 21 for the application material, wherein the distribution recess 21 penetrates the further nozzle element 20 completely, as shown, e.g., in FIG. 3.

The distribution recess 21 of the further nozzle element 20 comprises a central recess 22, both-sided outside protruding projections 23, and both-sided between the projections 23 and the central recess 22 respectively a, substantially straight, edge region 24.1, 24.2.

The central recess 22 comprises a central arcuate section 22.1 and two outer arcuate sections 22.2, 22.3 adjacent to the central arcuate section 22.1.

As can be seen in FIG. 5, the distribution edge 3.2 can at the top connect with a first end to a transition region between the first outer arcuate section 22.2 and the first edge region 24.1. The distribution edge 3.2 can at the bottom connect with a second end to a transition region between the central arcuate section 22.1 and the second outer arcuate section 22.3.

The distribution recess 2 of the nozzle element 1 and the distribution recess 21 of the further nozzle element 20 overlap one another and/or form a common distribution chamber for the application agent, which can also be seen, e.g., in FIG. 5.

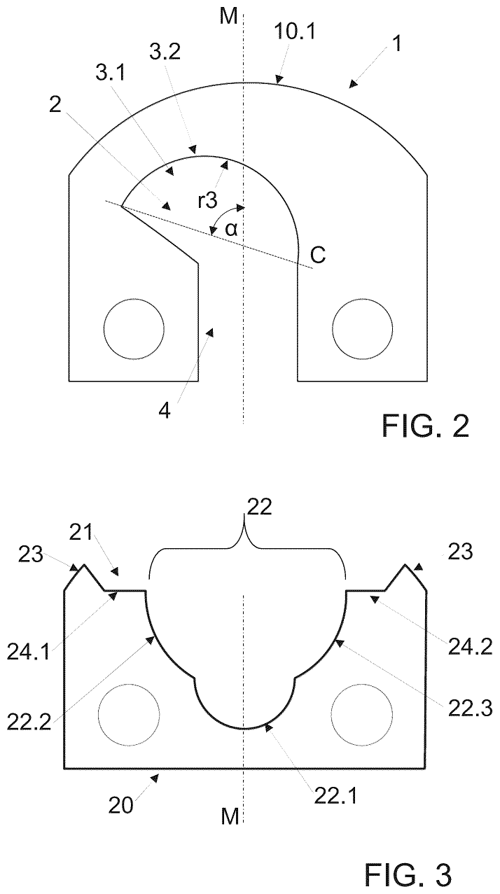

The distribution recess 2 of the nozzle element 1 is closed on the squirt side (e.g. FIG. 2), wherein the distribution recess 21 of the further nozzle element 20 is open on the squirt side (e.g. FIG. 3). The distribution recess 2 of the nozzle element 1 can open orthogonally to the nozzle element 1, in particular orthogonally to the plate plane of the nozzle element 1, into the distribution recess 21 of the further nozzle element 20, in particular at least partially within and at least partially outside the central recess 22 (e.g. FIG. 5).

Like the nozzle element 1, the additional nozzle element 30 comprises a front-sided, in particular convexly curved, squirting edge 30.1, but can alternatively also have a straight squirting edge 30.1.

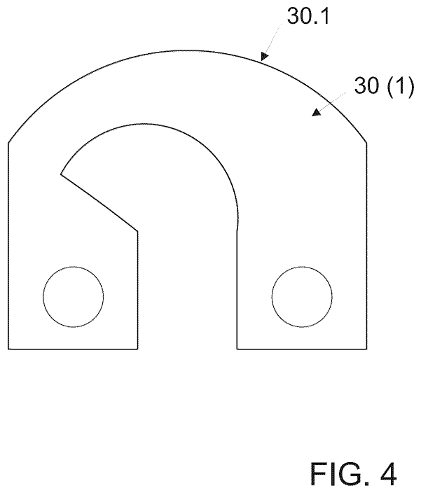

As can be seen, e.g., from FIG. 4, the additional nozzle element 30 can be formed to be substantially identical in construction to the nozzle element 1, so that the additional nozzle element 30 can have the features of the nozzle element 1 as disclosed herein. The disclosure relating to the nozzle element 1 thus also applies for the additional nozzle element 30.

The distribution recess 2, the indentation 3.1, the distribution edge 3.2, the feed channel 4 and/or the squirting edge 10.1 of the nozzle element 1 and the distribution recess, the indentation, the distribution edge, the feed channel and/or the squirting edge 30.1 of the additional nozzle element 30.1 are substantially aligned flush with one another (in particular arranged substantially congruently) and/or extend substantially parallel to one another.

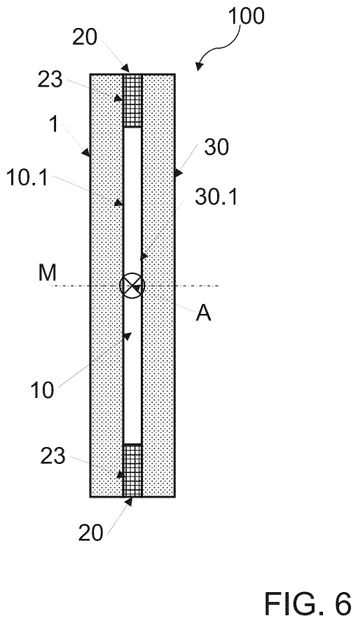

The outlet opening 10 extends between the squirting edge 10.1 of the nozzle element 1 and the squirting edge 30.1 of the additional nozzle element 30, and at least partially between the projections 23 of the further nozzle element 20, as shown, e.g., in FIGS. 1 and 6.

The nozzle device 100 can, e.g., have a center plane M which is defined by a center axis A of the outlet opening 10 and which can be aligned orthogonally to the slot-shaped outlet opening 10 and/or orthogonally to the plate plane or generally the element plane of the nozzle element 1, of the further nozzle element 20 and/or of the additional nozzle element 30.

The distribution recess 2, the indentation 3.1 and/or the distribution edge 3.2 of the nozzle element 1 can be formed asymmetrically, in particular relative to the center plane M.

The outlet opening 10, the squirting edge 10.1 of the first nozzle element 1, the distribution recess 21 of the further nozzle element 20, and/or the squirting edge 30.1 of the additional nozzle element 30 can be formed essentially symmetrically, in particular relative to the center plane M.

FIG. 2 shows, e.g., that the indentation 3.1 and/or the distribution edge 3.2 can have a chord C, wherein the chord C, in particular relative to the center plane M, can have a chord angle α of less than 90°, 85° or 80° and/or of greater than 55°, 60° or 65°. In FIG. 2, the chord angle α is approximately 70° by way of example.

The nozzle device 100 functions in particular substantially as follows.

The in particular viscous or highly viscous application material has the property of seeking out the path of least resistance through the nozzle device 100.

The distance d1 (passage gap) of the nozzle element 1 is shorter on one side of the outlet opening 10 (e.g. 3 mm) than on the other side (e.g. 6 mm), wherein the distances d1, d2 can be varied, e.g. depending on the boundary conditions (e.g. viscosity of the application material, desired layer thickness distribution, etc.).

The nozzle device 100 generates a higher flow resistance for the application material on one side (e.g. on the right in FIG. 5) than on the other side (e.g. on the left in FIG. 5).

With reference to FIG. 5, the application material flowing in from below first seeks the path (left) at distance d1 because it can flow out faster there due to the lower flow resistance.

As the material flow increases, the squirt jet S moves further and further in the direction of distance d2 and also forces its way through at distance d2. This happens because a backlog forms in the nozzle device 100 due to the higher material flow and the application material cannot flow out quickly enough at distance d1 with the lower flow resistance.

The pressure in the nozzle device 100 increases and the application material is also forced outwards at the distance d2 with the higher resistance.

The layer thickness of the application produced on the motor vehicle component 200, in particular an application path, is here asymmetrical in cross-section.

The disclosure makes it advantageously possible, e.g., to produce, with a squirt jet S, an application with an application thickness varying in cross-section (e.g. flattening or increasing) on a motor vehicle component 200, e.g. with an optimum setting angle of the nozzle device 100 to the surface of the motor vehicle component 200 of, e.g., approximately 90°.

The disclosure makes it advantageously possible, with an ideal setting angle (e.g. approximately) 90° of an applicator carrying the nozzle device 100 relative to the motor vehicle component 200, to produce a sharp application edge at the top and to produce a layer thickness of the application that increases substantially continuously from top to bottom.

At the lateral edge of the application, there is usually the effect of edge accumulation of the application material on both sides, wherein in the embodiment shown in FIG. 5, the right end of the outlet opening 10 would produce a smaller edge accumulation than the left end.

FIGS. 1 to 6 relate to an embodiment in which the projections 23 are arranged substantially flush with the squirting edge 10.1 of the nozzle element 10 and with the squirting edge 30.1 of the additional nozzle element 30, so that the projections 23 delimit the outlet opening 10 outside on both sides and/or between the projections 23 and the squirting edge 10.1 of the nozzle element 1 and the squirting edge 30.1 of the additional nozzle element 30 there is on both sides no passage gap for the application agent.

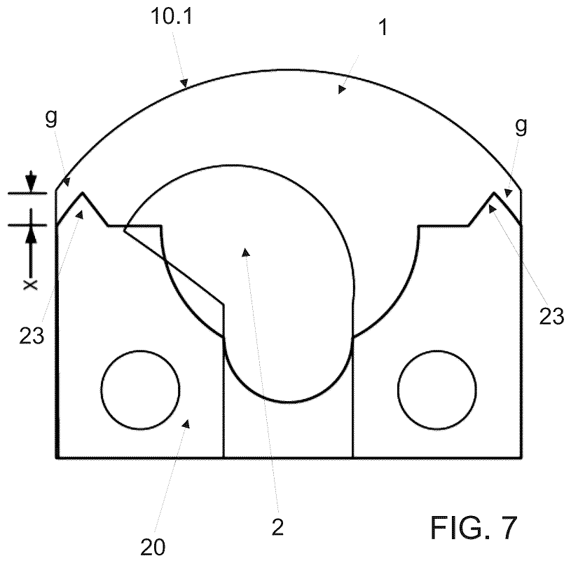

FIG. 7 illustrates an embodiment in which the projections 23 are offset, in particular set back, to the squirting edge 10.1 of the nozzle element 1 and the squirting edge 30.1 of the additional nozzle element 30, in order to produce on both sides a passage gap g (e.g. with a height x of between 0.1 mm and 2.0 mm) for the application agent. This makes it advantageously possible to reduce an edge accumulation of an application produced on the motor vehicle component 200. Consequently, application material, e.g., can advantageously be saved at points that were previously usually accepted as overcoating.

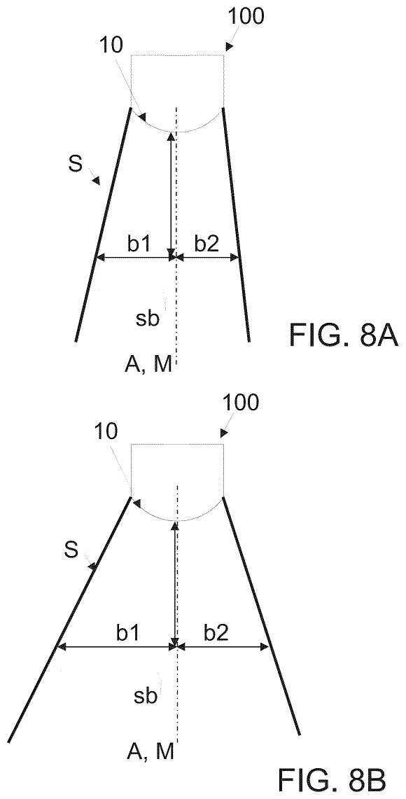

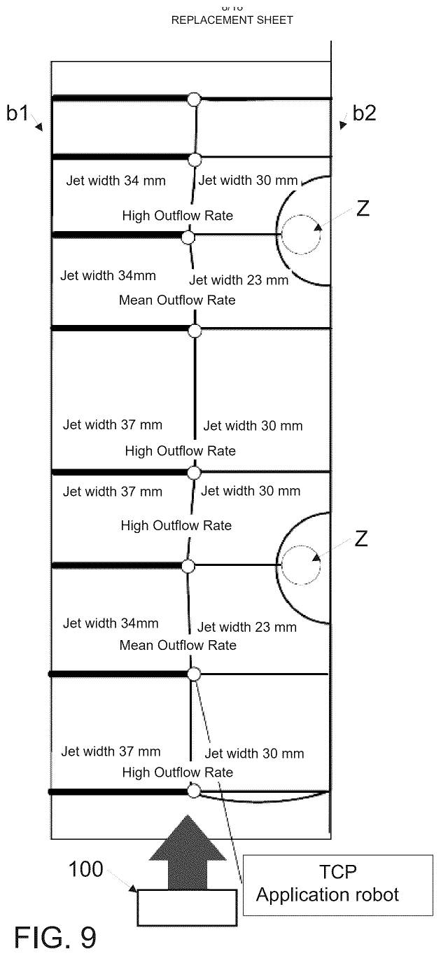

The disclosed technology can also be used (e.g. FIGS. 8A, 8B and 9) to generate an asymmetrical squirt jet S and/or to asymmetrically change a jet width sb, sb1, sb2 of the squirt jet S, so that relative to the center axis A of the outlet opening 10, a first jet width b1 on one side of the center axis A is greater than a second jet width b2 on the other side of the center axis A, and/or a center axis of the squirt jet S deviates from a center axis A of the outlet opening 10.

An asymmetrical squirt jet S can, e.g., be used, to, in an advantageous manner, deliberately bypass partial sections Z (e.g. holes or bolts) on a motor vehicle component 200 by the squirt jet S, optionally in combination with an evasive movement (produced by an application robot) of the nozzle device 100 (of, e.g., only about 2 mm to 4 mm), as shown, e.g., in FIG. 9. In FIG. 9, the arrow indicates the direction of movement of the nozzle device 100, wherein TCP stands for Tool Center Point.

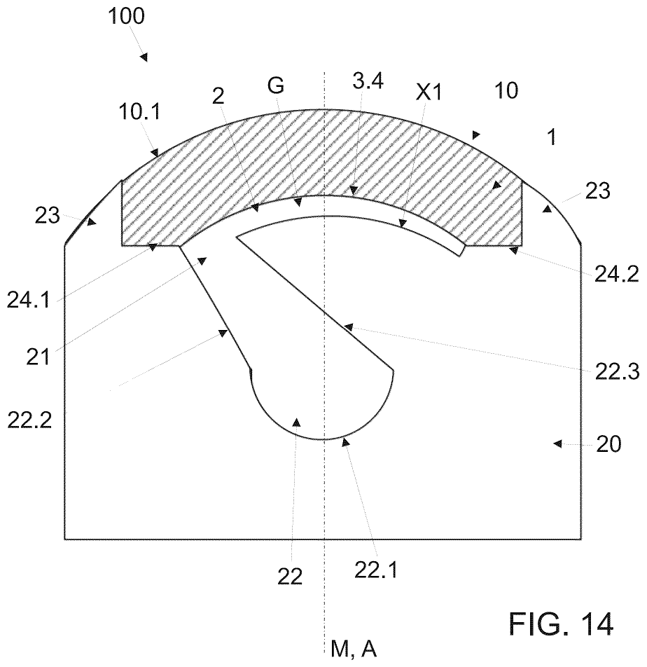

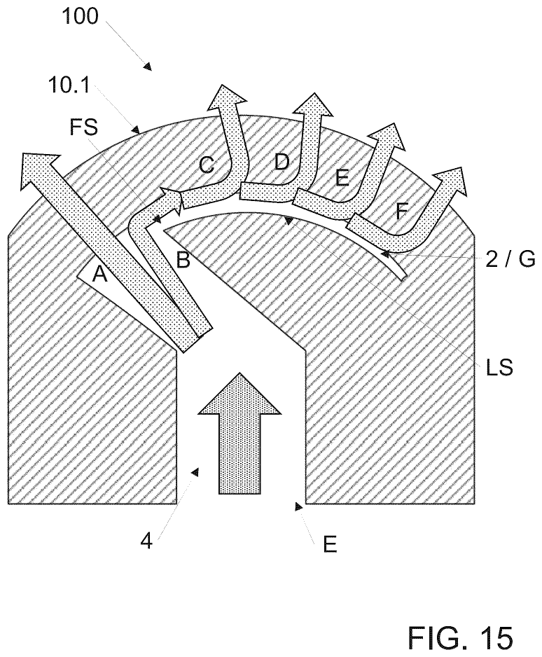

A nozzle device 100 according to another embodiment of the disclosure is described below with reference to FIGS. 12 to 15.

FIGS. 12 to 15 show an embodiment in which both nozzle elements shown have an asymmetrical distribution recess 2/21. Thus, the nozzle element shown in FIG. 12 can be designated as “nozzle element 1” and the nozzle element shown in FIG. 13 can be designated as “further nozzle element 20”, but it is also possible to designate the nozzle element shown in FIG. 12 as “further nozzle element 20” and to designate the nozzle element shown in FIG. 13 as “nozzle element 1”. By way of example, the nozzle element shown in FIG. 12 is referred to below as nozzle element 1 and the nozzle element shown in FIG. 13 is referred to as further nozzle element 20.

The further nozzle element 20 (inner plate) is arranged between the nozzle element 1 (outer plate) and an additional nozzle element 30 (outer plate) (see, e.g., FIG. 1), wherein the additional nozzle element 30 is formed substantially identical in construction to the nozzle element 1. The nozzle element 1, the further nozzle element 20 and the additional nozzle element 30 can be clamped between two clamping parts.

The nozzle device 100 and/or the nozzle element 1 comprises an asymmetrical distribution recess 2 for the application material, in order to distribute a material quantity asymmetrically along the outlet opening 10 and/or in order to dispense a material quantity that changes, continuously, along the outlet opening 10.

The nozzle element 1 comprises a feed channel 4. The feed channel 4 has an entry opening E for the application material at a front side of the nozzle element 1, wherein the entry opening E and the outlet opening 10 are aligned in opposite directions. The feed channel 4 opens into the distribution recess 2.

The nozzle device 100, in particular the nozzle element 1, comprises an in particular elongated, sickle-shaped distribution slot G for the application material, wherein the distribution slot G forms at least part of the distribution recess 2, extends in an arcuate shape and, in particular, narrows along its longitudinal extension.

The distribution slot G is delimited by a convex, arcuate, edge segment 3.3 and a concave, arcuate, edge segment 3.4, which extends, e.g., opposite the convex edge segment 3.3.

The convex edge segment 3.3 and the concave edge segment 3.4 are part of the nozzle element 1, but embodiments are possible in which the convex edge segment 3.3 and/or the concave edge segment 3.4 is part of the further nozzle element 20.

The concave edge segment 3.4 can correspond to a distribution edge for the application material.

The distribution slot G can furthermore be delimited by a convex, arcuate, edge segment X1, which extends, e.g., opposite the concave edge segment 3.4.

The convex edge segment X1 is part of the further nozzle element 20.

The distribution slot G can thus be delimited by the concave edge segment 3.4 and the convex edge segment 3.3 of the nozzle element 1 as well as by the convex edge segment X1 of the further nozzle element 20.

The concave edge segment 3.4 delimits the distribution slot G on the squirt side, so that the distribution slot G is closed on the squirt side. The distribution recess 21, on the other hand, is open on the squirt side.

The convex edge segment 3.3 and the convex edge segment X1 extend substantially parallel to one another and can be aligned, e.g., substantially flush with one another along their longitudinal extension.

The convex edge segments 3.3, X1 and the concave edge segment 3.4 have different radii of curvature.

The convex edge segment 3.3 comprises a chord C that, relative to the center plane M, has a chord angle α of less than 90° and greater than 55°. In FIG. 12, the chord angle α is, for example, approximately 80°.

The convex edge segment X1 also includes a chord that can have a chord angle relative to the center plane M of, e.g., less than 90° and greater than 55°. In FIG. 13, the chord angle is, for example, approximately 85°. In FIG. 13, the chord and the chord angle of the convex edge segment X1 are not provided with reference signs.

The further nozzle element 20, in particular its distribution recess 21, comprises, e.g., a central recess 22, both-sided outside protruding projections 23 and two edge regions 24.1, 24.2, a first edge region 24.1 and a second edge region 24.2, of which respectively one is arranged between the projections 23 and the central recess 22.

The central recess 22 comprises a central arcuate section 22.1 and two outer side sections 22.2, 22.3 adjacent to the central arcuate section 22.1, namely a first outer side section 22.2 and a second outer side section 22.3. The side sections 22.2, 22.3 are formed, e.g., as linear section.

The convex edge segment 3.3 and the convex edge segment X1 are arranged between the first edge region 24.1 and the second edge region 24.2, wherein the convex edge segment 3.3 and the convex edge segment X1 are spatially distanced from the first edge region 24.1 to create a passage for the application material, but can be connected to the second edge region 24.2 so as not to create a passage for the application material.

The feed channel 4, the distribution slot G and the distribution recess 2 extend completely orthogonally through the nozzle element 1, so that the nozzle element 1 is completely penetrated orthogonally to its element plane.

The distribution recess 21 extends completely orthogonally through the further nozzle element 21, so that the further nozzle element 21 is completely penetrated orthogonally to its element plane.

FIGS. 12 to 15 show an embodiment in which the nozzle device 100, the distribution recess 2 comprising the distribution slot G, produces different path resistances for the application material, according to which the application material is distributed along the outlet opening 10.

Here, the application material flows through the distribution recess 2 and/or the distribution slot G in the longitudinal direction of the distribution recess 2 and/or of the distribution slot G and flows out, transversely to the longitudinal direction, from the distribution recess 2 and/or the distribution slot G, wherein the distribution recess 2 and/or the distribution slot G generates in particular different path resistances for the application material.

With reference to FIG. 15, the principle of the different path resistances functions in particular substantially as follows:

The in particular viscous or highly viscous application material has the property of seeking out the path of least resistance through the nozzle device 100.

The application material along arrow A has a short and/or resistance-free path and can flow out without resistance.

The application material along arrow B, C has a longer path and thus also a higher resistance when flowing out.

The application material along arrows B, C, D, E has an even longer path and thus an even higher resistance.

The application material along arrows B, C, D, E, F has the longest path and thus also the greatest resistance.

Therefore, the application material along the arrows C, D, E, F is reduced along the outlet opening 10.

The reduced quantity of the application material depends on the narrowing (tapering) of the distribution slot G and thus on the narrowing of the distribution recess 2.

In the embodiment of FIG. 15, the application material is introduced into the distribution recess 2 and/or the distribution slot G via an open front side SF of the distribution recess 2 and/or of the distribution slot G. Here, the longitudinal side LS of the distribution recess 2 and/or of the distribution slot G can be closed, so that no application material can be introduced via the longitudinal side LS.

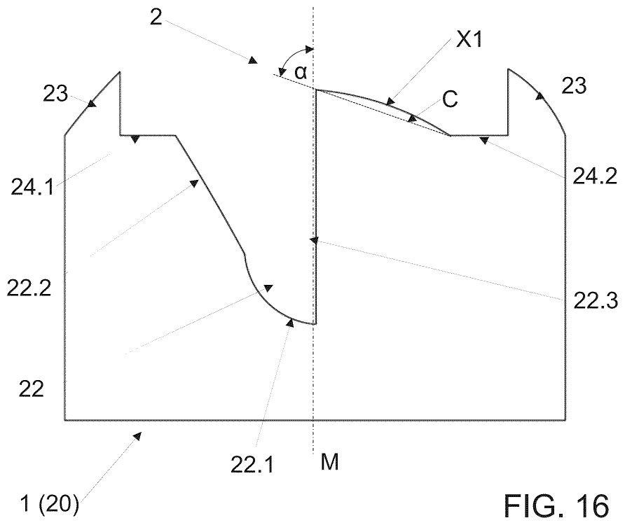

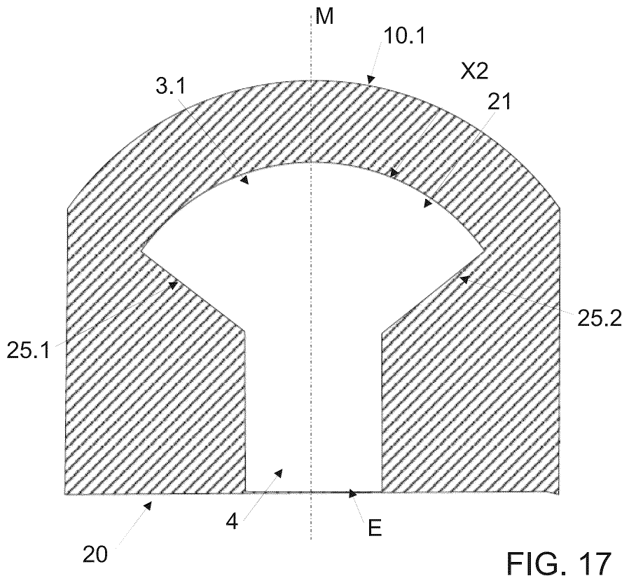

In the following, a nozzle device 100 according to another embodiment of the disclosed technology is described with reference to FIGS. 16 to 19.

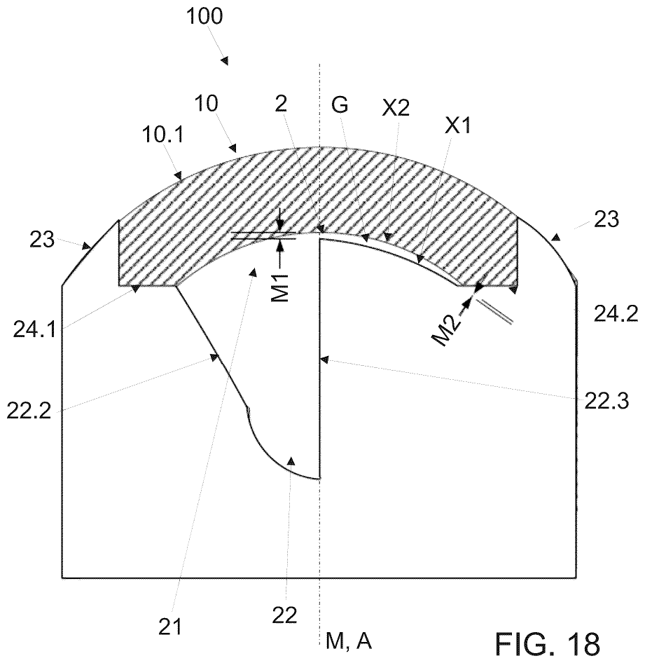

The nozzle element 1 shown in FIG. 16 comprises an asymmetrical distribution recess 2, but also features that are assigned to the further nozzle element in the previously explained embodiments. Thus, the nozzle element shown in FIG. 16 can be designated as “nozzle element 1”, but it is also possible to designate the nozzle element shown in FIG. 16 as “further nozzle element 20”. By way of example, the nozzle element shown in FIG. 16 is referred to below as “nozzle element 1” and the nozzle element shown in FIG. 17 is referred to as “further nozzle element 20”.

The nozzle element 1 (inner plate) is arranged between the further nozzle element 20 (outer plate) and an additional nozzle element 30 (outer plate) (see, e.g., FIG. 1), wherein the additional nozzle element 30 is formed to be substantially identical in construction to the further nozzle element 20. The nozzle element 1, the further nozzle element 20 and the additional nozzle element 30 can be clamped between two clamping parts.

The nozzle device 100 and/or the nozzle element 1 comprises an asymmetrical distribution recess 2 for the application material, in order to distribute a material quantity asymmetrically along the outlet opening 10 and/or in order to dispense a material quantity that changes, continuously, along the outlet opening 10.

The nozzle device 100 comprises a particularly elongated, sickle-shaped distribution slot G for the application material, wherein the distribution slot G forms at least a part of the distribution recess 2, extends in an arcuate shape and, in particular, narrows along its longitudinal extension.

The distribution slot G is delimited by a convex, arcuate, edge segment X1 and a concave, arcuate, edge segment X2, which extends, e.g., opposite the convex edge segment X1.

The convex edge segment X1 is part of the nozzle element 1, but embodiments are possible in which the convex edge segment X1 is part of the further nozzle element 20.

The concave edge segment X2 is part of the further nozzle element 20.

The distribution slot G is thus delimited by the concave edge segment X2 of the further nozzle element 20 as well as by the convex edge segment X1 of the nozzle element 1.

The convex edge segment X1 and the concave edge segment X2 have different radii of curvature.

The concave edge segment X2 delimits the distribution recess 21 and/or the distribution slot G on the squirt side, so that the distribution recess 21 and/or the distribution slot G is closed on the squirt side. The distribution recess 2, on the other hand, is open on the squirt side.

The convex edge segment X1 comprises a chord C, which has a chord angle α of less than 90° and greater than 55° relative to the center plane M. In FIG. 16, the chord angle α is, for example, approximately 70°.

The further nozzle element 20 has a feed channel 4 for feeding the application material, wherein the feed channel 4 opens into the distribution recess 21. The feed channel 4 can comprise an entry opening E for the application material at a front side of the further nozzle element 20.

The further nozzle element 20 comprises a particularly symmetrical distribution recess 21. The distribution recess 21 is delimited by two side edges 25.1, 25.2 and the concave edge segment X2. The two side edges 25.1, 25.2 widen towards the concave edge segment X2 and connect both-sided to the concave edge segment X2.

FIGS. 16 to 19 show an embodiment in which the nozzle device 100, the distribution recess 2 comprising the distribution slot G, produces different gap resistances for the application material, according to which the application material is distributed along the outlet opening 10.

Here, the application material flows into the distribution recess 2 and/or the distribution slot G transversely to the longitudinal direction of the distribution recess 2 and/or of the distribution slot G and, after a change of direction, exits, transversely to the longitudinal direction, the distribution recess 2 and/or the distribution slot G, wherein the distribution recess 2 and/or the distribution slot G generates in particular different gap resistances for the application material.

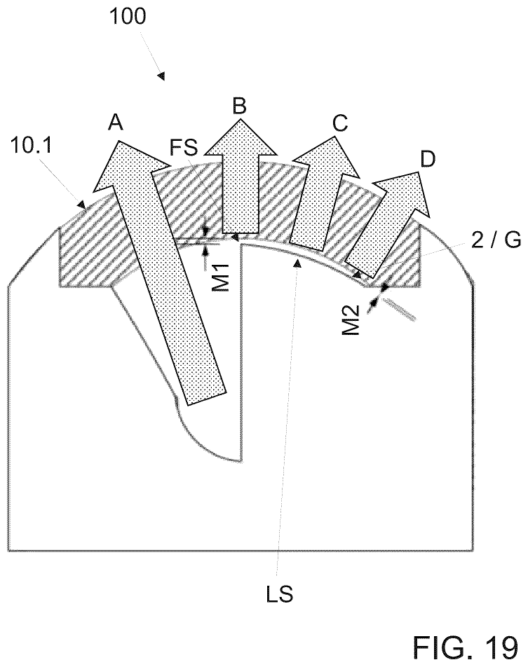

The principle of the different gap resistances functions, with reference to FIG. 19, substantially as follows:

The in particular viscous or highly viscous application material has the property of seeking out the path of least resistance through the nozzle device 100.

The application material along arrow A has a short and/or resistance-free path and can flow out without resistance.

The application material along arrows B, C and D has to force its way through the distribution slot G between the nozzle element 1 (in particular middle plate) and the further nozzle element 20 (in outer plate) before it can emerge from the outlet opening 10.

The distribution slot G between the nozzle element 1 (in particular middle plate) and the further nozzle element 20 (in particular outer plate) decreases from dimension M1 to dimension M2 by x mm.

Thus, the quantity of the application material is reduced by the increased (gap) resistance in the material flow B, C, D.

In the embodiment of FIG. 19, the application material is introduced via an open longitudinal side LS (and optionally an open front side FS) of the distribution recess 2 and/or of the distribution slot G into the distribution recess 2 and/or the distribution slot G, in order to distribute a material quantity asymmetrically along the outlet opening 10 and/or to dispense a material quantity that changes, continuously, along the outlet opening 10.

The disclosure is not limited to the embodiments described above. Rather, the disclosure also encompasses combinations, variations, and modifications that also make use of the disclosed technology and therefore fall within the scope of this disclosure.

1.-41. (canceled)

42. A nozzle device for dispensing a squirt jet of an application material, comprising:
a slot-shaped and convexly curved outlet opening for the application material; and
a nozzle element, wherein the nozzle element has an asymmetrical distribution recess for the application material to distribute a material quantity asymmetrically along the outlet opening.

43. The nozzle device according to claim 42, wherein the distribution recess has a concave indentation for the application material.

44. The nozzle device according to claim 42, wherein the distribution recess has a distribution edge for the application material, via which the application material can be fed to the outlet opening.

45. The nozzle device according to claim 43, wherein the indentation and the distribution edge has at least partially an arcuate shape.

46. The nozzle device according to claim 45, wherein the nozzle element has a convexly curved squirting edge.

47. The nozzle device according to claim 46, wherein a distance between the distribution edge and the squirting edge increases along the distribution edge by at least the factor of 1.2.

48. The nozzle device according to claim 42, wherein the nozzle device has a sickle-shaped, distribution slot for the application material, wherein the distribution slot forms a part of the distribution recess and extends in an arcuate shape that narrows along its longitudinal extension.

49. The nozzle device according to claim 48, wherein the distribution slot is delimited by a convex edge segment and a concave edge segment.

50. The nozzle device according to claim 49, wherein the convex edge segment has a longitudinal extension and the concave edge segment has a longitudinal extension, wherein the longitudinal extension of the convex edge segment is smaller than the longitudinal extension of the concave edge segment.

51. The nozzle device according to claim 42, wherein the application material flows in the longitudinal direction of the distribution recess, through the distribution recess, and exits transversely to the longitudinal direction.

52. The nozzle device according to claim 42, wherein the nozzle device has a further nozzle element and the further nozzle element comprises a, substantially asymmetrical distribution recess for the application material, and a convexly curved squirting edge.

53. The nozzle device according to claim 52, wherein the nozzle element and the further nozzle element have a feed channel for feeding the application material, wherein the feed channel opens into the distribution recess of the nozzle element and the distribution recess of the further nozzle element.

54. The nozzle device according to claim 53, wherein the distribution recess of the nozzle element and the distribution recess of the further nozzle element overlap one another to form a common distribution chamber for the application material.

55. The nozzle device according to claim 52, wherein the nozzle element and the further nozzle element each have a central recess, both-sided outside protruding projections, and two edge regions, one of which is arranged between the projections and the central recess.

56. The nozzle device according to claim 55, wherein the central recess has a central arcuate section and two outer side sections adjacent to the central arcuate section, namely a first outer side section and a second outer side section.

57. The nozzle device according to claim 56, wherein the distribution recess of the nozzle element is squirt-sided open orthogonally to the nozzle element into the distribution recess of the further nozzle element.

58. The nozzle device according to claim 57, wherein the distribution recess extends completely orthogonally through the nozzle element and the distribution recess extends completely orthogonally through the further nozzle element.

59. The nozzle device according to claim 42, wherein the nozzle device comprises an additional nozzle element which has a convexly curved squirting edge.

60. The nozzle device according to claim 59, wherein the additional nozzle element is designed to be identical in construction to the nozzle element.

61. The nozzle device according to claim 60, wherein a further nozzle element is arranged between the nozzle element and the additional nozzle element.
